(19) United States
(12) Patent Application Publication
(10) Pub. No.: US 2007/0212437 A1
(43) Pub. Date: Sep. 13, 2007

(54) Recycled Polymeric Composite Crossties and Methods of Manufacture

(75) Inventors: Geoffrey Wilson, Heber City, UT (US); Vernon Wilson, Heber City, UT (US); Sterling Stoddard, American Fork, UT (US); Ryan Nielson, Monticello, UT (US); Richard Brunst, Orem, UT (US); David Warren Smith, Heber City, UT (US); Philip J. Danielson, Monticello, UT (US)

Correspondence Address: MERCHANT & GOULD PC, P.O. BOX 2903, MINNEAPOLIS, MN, 55402-0903, US

(73) Assignee: Recycle Technologies International LLC, Orem, UT (US)

(21) Appl. No.: 11/747,840

(22) Filed: May 11, 2007

Related U.S. Application Data
(62) Division of application No. 10/914,894, filed on Aug. 9, 2004.

(51) Int. Cl. B29C 47/08

(52) U.S. Cl. 425/205

(57) ABSTRACT

A polymeric composite useful for producing large shaped articles such as railroad crossties comprises a filler component having minimal reinforcing/structural characteristics; and a polymer blend including at least one polymeric stiffening component, at least one polymeric density component, and at least one polymeric flexibility component. The polymer blend can include post-consumer recycled thermoplastic polymers. To produce the composite, a multistage extruder brings a blend of polymer and filler materials to an extrudable threshold without completely liquefying the polymer blend. The extruded blend is cooled within a mold to form a shaped article such as a recycled composite crosstie. Exemplary recycled composite mixtures may include composite polymer materials, such as, polypropylene, High Density Polyethylene (HDPE), High Molecular Weight Polyethylene (HMW), Low Density Polyethylene (LDPE), ABS, Ethylene Vinyl Acetate (EVA), Linear Low Density Polyethylene (LLDPE), and combinations of these polymers. The filler may include talc, fly ash, potash, and combinations of these or other mineral powder products.

### CROSS-REFERENCE TO RELATED APPLICATION

This application claims the benefit of U.S. Provisional Patent application 60/493,681 originally filed Aug. 8, 2003 under 35 U.S.C. 119(e); the prior application is herewith incorporated by reference in its entirety.

### TECHNICAL FIELD

The present invention relates to polymeric composite materials. More particularly, the present invention relates to improving composite construction materials, such as crossties, grade crossings, marine and utility piles, and other dimensional lumber. Such materials can advantageously be made with recycled polymeric materials, particularly post-consumer recycled materials.

### BACKGROUND AND RELATED ART

Industrial construction often requires materials be placed in corrosive environments. Environmental exposure drastically affects life cycle costs and durability for these materials. Exemplary materials include railroad crossties, marine pilings, utility and electric poles, fencing, railing, lumber, and decking. These materials are often constructed from raw materials including wood, concrete, steel, and composite components.

One of these corrosive industrial environments is the railroad industry. Railroad crossties are used to position the rails and have traditionally been made almost exclusively of wood. To increase the life cycle of wood crossties they are often treated with chemicals, such as creosote, but even creosote wood crossties only have an expected useful life of less than 5 years in harsh railroad environments. Unfortunately, the use of pressure treated wood creates a potential for toxins to leach into the ground as the chemicals injected into pressure treated wood are released into the soil and create potentially hazardous conditions. Moreover, the production of creosote often generates additional byproducts that are highly regulated as being potentially hazardous.

In addition, the supply of the raw materials necessary to produce wood crossties is presently impeded by various restrictions imposed on forestry operations in United States. Because of these restrictions, quality hardwoods are in tight supply. In light of the declining areas of mature forests and environmental pressure to protect trees, products using recycled materials to replace products presently using these protected hardwoods are needed.

Unfortunately, manufacturing products employing polymeric composites have heretofore been cost prohibitive, provided inconsistent quality, and were incapable of being produced in large quantities. Moreover, many polymeric composites include materials that actually contribute to their ultimate failure, such as wood and rubber by-products. Wood byproducts function as a “water superhighway” when used as fillers in polymeric composites drawing unwanted water, which then expands and contracts, according to external temperature, in the product thereby greatly diminishing the overall life cycle of the product. Rubber fillers, such as recycled tires, introduce devastating beat expansion coefficient into the composite, which consequences that are destructive on rail gauging in a crosstie application for example.

### SUMMARY OF THE INVENTION

In view of these difficulties previously associated with known methods for manufacturing polymeric composites and the limitations of available solutions, the present invention has been developed to satisfy the need for economically viable and environmentally sensitive processes and products. More specifically, the polymeric composite of the present invention allows for production of reliable structurally demanding shaped articles, such as crossties, grade crossings, and piles for use in marine and utility applications. In accordance with another feature of the invention, the polymeric composite includes a polymer blend with recycled materials, which may include either post-consumer or post-industrial waste.

One aspect of the invention is a series of polymeric composites that can be of industrial waste in nature, in which about 80% will not pass through a 60 micron screen, and a filler that has no known structural properties comprised of talc (Magnesium Silicate Hydroxide), pot ash, fly ash, or any combination of these mineral products of which 100% will pass through a 60 micron screen. Such a polymeric composite comprises a filler component having minimal reinforcing/structural characteristics and a polymer blend including at least one polymeric stiffening component, at least one polymeric density component, and at least one polymeric flexibility component. The polymeric composite preferably contains between about 50 and about 90 percent by weight of the polymer and preferably contains between about 10 and about 50 percent by weight of the mineral based filler, which is non-structural in nature. The polymeric composite more preferably contains between about 22 to about 38 percent by weight of the filler. In the polymeric composite according to the invention, the polymer blend preferably comprises polymeric materials selected from the group consisting of polypropylene, High Density Polyethylene (HDPE), High Molecular Weight Polyethylene (HMW), Low Density Polyethylene (LDPE), ABS, Ethylene Vinyl Acetate (EVA), Linear Low Density Polyethylene (LLDPE), Polyvinyl Chloride, and combinations thereof.

The at least one polymeric stiffening component of the polymer blend used in the composite of the invention is selected from the group consisting of High Density Polyethylene (HDPE), polypropylene, High Molecular Weight Polyethylene (HMW), ABS, and mixtures thereof. The polymeric composite includes less than about 60 percent by weight of the at least one polymeric stiffening component.

The at least one polymeric density component of the polymer blend used in the composite of the invention is selected from the group consisting of High Density Polyethylene (HDPE), High Molecular Weight Polyethylene (HMW), and combinations thereof. The polymeric composite includes between about 15 percent by weight to about 35 percent by weight of the at least one polymeric density component.

The at least one polymeric flexibility component of the polymer blend used in the composite of the invention is selected from the group consisting of Low Density Polyethylene (LDPE), EVA, Linear Low Density Polyethylene (LLDPE), and ABS. The polymeric composite includes between about 10 percent by weight to about 35 percent by weight of the at least one polymeric flexibility component.

While the polymer blend in the composition of the invention includes a polymeric stiffening component, a polymeric density component, and a polymeric flexibility component, three functional components in all, more than one function can be fulfilled by one kind of polymer. Thus, high-density polyethylene can, for example, function as both a stiffening component and a density component in one composition when another flexibility component is present. Moreover, the present invention can also use more than one substance for each type of polymeric component (stiffening, flexibility, and density).

In a particularly preferred embodiment, the polymeric composite of the invention consists essentially of High Density Polyethylene (HDPE), Low Density Polyethylene (LDPE), and Talc.

In a further particularly preferred embodiment, the polymeric composite of the invention includes about 0 percent by weight to about 30 percent by weight polypropylene, between about 15 percent by weight and about 60 percent by weight HDPE, between about 15 to about 35 percent by weight LDPE, and between about 10 to about 40 percent by weight Talc.

In a particularly preferred embodiment, the polymeric composite of the invention comprises recycled polymeric materials, particularly post-consumer recycled polymeric materials.

Another aspect of the invention is a shaped article comprising the polymeric composite of the invention. Such shaped articles can include large and massive structures, weighing upwards of fifty pounds each, such as railroad crossties, grading crossings, marine pilings, utility poles, home construction joists, and other structural shapes traditionally made from wood. The ability to provide such products by utilizing recycled polymeric materials without sacrificing valuable natural resources represents one important aspect of the invention.

In the manufacture of the polymeric composite of the invention, the polymeric composite softens and combines at a first transition threshold to form an extrudable configuration. The extrudable configuration solidifies into a molded configuration once the outside surface of the polymeric composite cools to a second transition threshold. In one aspect of the invention, the second transition threshold occurs when the molded configuration shrinks between about 1 percent by volume and about 2 percent by volume.

Another aspect of the invention concerns a method for producing a polymeric composite. The method includes the steps of mixing filler material and polymer material to form a composite material, heating the composite material to less than a melting temperature threshold, extruding the composite material into at least one mold, and compressing the composite material within said at least one mold. The melting temperature threshold is a temperature at which the polymer blend is softened, but not melted or liquefied. In one embodiment, the mold is initially cooler than the polymeric composite being extruded into the mold. Initially, the mold is suitably maintained at ambient temperature.

Heating the composite material can include staged heating within an extruder to a temperature less than a transition threshold of the composition material. The transition threshold during heating within an extruder is referred to herein as a first transition threshold. A transition threshold during cooling in a mold is referred herein to as a second transition threshold. The first transition threshold is at a temperature between about 280° F. and about 520° F. and at a pressure between about 800 psi and 5000 psi. Temperature and pressure are to some extent interdependent, higher temperatures accommodating lower pressures and vice versa. The polymeric composite softens and combines at the first transition threshold to form an extrudable configuration.

In another aspect of the invention, the method can include selecting the composition material from the group consisting of polypropylene, High Density Polyethylene (HDPE), High Molecular Weight Polyethylene (HMW), Low Density Polyethylene (LDPE), ABS, Ethylene-vinyl acetate (EVA), Linear Low Density Polyethylene (LLDPE), or combination thereof.

In one aspect of the invention, the method includes extruding the composite material into the mold at a compression pressure between about 600 psi and about 3100 psi. Preferably, the compression pressure within the mold from extrusion is between about 1700 psi and about 3000 psi.

In the method of the invention, the mold dimensions can comply with the American Railroad Engineering and Maintenance of Way Association (AREMA) specifications for composite railroad ties.

In another aspect of the invention, the method includes cooling an exterior portion of the composite material within the mold and removing the composite material from the mold prior to complete cooling or solidification.

In another aspect of the invention, there is provided a system of manufacture including a means for sizing a polymer for extrusion, a mixer and feeder, an extruder having multiple adjustable heat zones for heating and blending a polymer blend having a polymeric stiffening component, a polymeric density component, and a polymeric flexibility component and a filler having minimal reinforcing/structural characteristics into a polymeric composite; and at least one extrusion compression mold structure operably coupled to the extruder for receiving the polymeric composite and discharging molded polymeric composite therefrom.

The means for sizing a polymer for extrusion depends on the nature of the polymer raw material available, which can come in a variety of sizes, from fine powders to substantial chunks of material. Accordingly, suitable means of sizing the polymer can subdivide large particles into smaller particles and compact very fine particles into larger aggregate particles, such that the resized particles conveniently flow in an Extruder. Suitable means for sizing a polymer for extrusion can be, for example, a granulator, a pelletizer, a prilling machine, a densifier, a grinder, and similar devices.

In the system according to the invention, the multiple heat zones are preferably heated between about 250 degrees Fahrenheit and about 520 degrees Fahrenheit. The multiple heat zones gradually heat particles of the polymeric composite until said particles can reach a transition threshold and begin to bond together.

In the system according to the invention, the polymeric composite is preferably heated to a temperature between about 350 degrees Fahrenheit and about 420 degrees Fahrenheit. The polymeric composite is preferably heated to a temperature threshold less than a melting point of the polymer blend of said composite so that a majority of polymer chains in the polymer blend is maintained. This minimizes undesirable changes in the consistency of the composite during processing.

In the system according to the invention, the polymeric composite is extruded at a pressure between about 2000 psi and about 3000 psi.

In the system according to the invention, each extrusion compression mold structure is quenched by a cooling agent, once the mold structure is filled, until the polymeric composite reaches the second transition threshold to solidify an exterior portion of the extruded polymeric composite within the mold structure. The at least one extrusion compression mold structure is preferably quenched by a cooling agent for between about 20 to about 120 minutes after being filled with the polymeric composite. The continuous movement of the composite through the extruder is coordinated with the periodic movement of the composite into and out of a mold by using a plurality of molds for receiving extrudate sequentially. Suitable coolants include water, chilled air, chilled oils, and chilled antifreeze solutions below the freezing point of water.

In the system according to the invention, the filler is selected from the group consisting of Talc, fly ash, potash, and combinations thereof. In one aspect the polymer is selected from the group consisting of polypropylene, High Density Polyethylene (HDPE), High Molecular Weight Polyethylene (HMW), Low Density Polyethylene (LDPE), ABS, Ethylene Vinyl Acetate (EVA), Linear Low Density Polyethylene (LLDPE), and combinations thereof.

In another aspect of the invention, the compression mold structure has inserts on three sides of each mold that create markings and/or molded designs in the polymeric composite.

Another aspect of the invention is wherein heat is transferred into the polymeric composite using an extrusion process with temperatures set between 140 and 500 degrees Fahrenheit to allow complete encapsulation of the non-structural filler as well as to allow bonding and solidification of the independent polymeric and filler compounds. The temperature is limited to duration and intensity so as not to liquefy the polymers or break down the polymeric bonds.

Furthermore, in another aspect of the invention the polymeric composite is forced into the molds via the extruder at a temperature between 140 and 500 degrees Fahrenheit and a pressure of between 1500 and 3000 psi. This composite is held in the molds and quenched in water that is between 30 and 70 degrees Fahrenheit for a time of between 20 and 60 minutes.

Furthermore, in another aspect of the invention the polymeric composite is forced into the molds via the extruder at a temperature between 280 and 520 degrees Fahrenheit and a pressure of between about 800 psi and about 5000 psi. Preferably the pressure is between about 1500 psi and about 3000 psi. This composite is held in the molds and quenched in water that is between 30 and 70 degrees Fahrenheit for a time of between 20 and 60 minutes.

With the above and other objects in view there is provided, in accordance with the invention, a method which includes sizing the polymer blend components of the composite to a suitable size for extruding the blend/composition materials, the composition material being selected from the group consisting of polypropylene, High Density Polyethylene (HDPE), High Molecular Weight Polyethylene (HMW), Low Density Polyethylene (LDPE), ABS, EVA, Linear Low Density Polyethylene (LLDPE), or combination thereof; heating a composition material to a first threshold; staged heating within an extruder to a temperature less than a transition threshold of the composition material; molding the composition material to a composite dimensional material; and cooling composite material to a second threshold.

In accordance with an added feature of the invention, the composite softens and combines at a first transition threshold to form an extrudable configuration.

In accordance with the invention, there is also provided an apparatus comprising: a means for sizing polymer blend components, which can be recycled plastic; to a size suitable for extrusion; a mixer and feeder; an extruder having multiple adjustable heat zones for heating and blending recycled plastic and filler into a polymeric composite; and multiple extrusion compression mold structures operably coupled to the extruder for receiving the polymeric composite.

Other features which are considered as characteristic for the invention are set forth in the appended claims.

Although the invention is illustrated and described herein as embodied in a extrusion method and apparatus for carrying out the method, it is nevertheless not intended to be limited to the details shown, since various modifications and structural changes may be made therein without departing from the spirit of the invention and still remain within the scope and range of equivalents of the claims.

For example, conventional optional plastics compounding ingredients, additives, and adjuvants can be added to the polymeric composite in minor amounts as needed, such as an antioxidant, a colorant, a flame retardant, and/or a lubricant or binding agent to bind the filler component to the polymeric blend before extrusion. Illustrative materials include antioxidants compiled in 21 CFR 178.2010; carbon black, titanium dioxide, and zinc oxide colorants; antimony trioxide together with a halogen source as flame retardant, and mineral oil as lubricant.

The construction and method of operation of the invention, however, together with additional objects and advantages thereof will be best understood from the following description of specific embodiments when read in connection with the accompanying drawings.

### BRIEF DESCRIPTION OF THE DRAWINGS

The invention is illustrated by way of example, and not by way of limitation, in the figures of the accompanying drawings in which like reference numerals refer to similar elements:

FIG. 1A is a perspective view from above of a polymeric composite crosstie;

FIG. 1B is a perspective view from above of a polymeric composite grade crossing;

FIG. 1C is a perspective view from above of a polymeric composite utility pole;

FIG. 1D is a side view of a polymeric composite marine pile;

FIG. 2 is a schematic block diagram of an extrusion system according to one embodiment of the invention;

FIG. 3 is an exploded perspective view from above of an extrusion compression mold;

FIG. 4 is a chart of pressure adjustment based in part on temperature; and

FIG. 5 is a flowchart of an extrusion compression system according to one embodiment of the invention.

### DETAILED DESCRIPTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

The present invention provides shaped articles such as railroad ties, suitably made of recycled polymeric composition, which in one aspect is characterized by a novel combination of materials

The invention will be illustrated in greater detail below with reference to working examples.

### Example 1

Railroad crossties were produced from a polymer composite according to the invention, made up of polypropylene, 17.5% by weight, high density polyethylene (HDPE), 35% by weight, low density polyethylene (LDPE), 17.5% by weight, and talc, 30% by weight, together with conventional additives, not exceeding 1% by weight of the polymer composite, including antioxidants and colors to provide a dark gray product. Fifteen of these crossties were submitted to an independent testing laboratory and eight of these tested as described in the laboratory's report, which follows:

Objectives

To determine the durability of eight plastic composite crossties made from the recycled materials after the 6-cycle laboratory accelerated aging test condition (Association of American Railroads Research Report No. R-702, 1987, AAR document TD96-01 0 dated April 1996 and AAR Research Report No. R-915, pages 17-18, 1997). Six cycles of this accelerated aging test may be equivalent to more than 20 years of natural aging in the Midwest of the United States (Proceedings of American Wood Preservers Association, AWPA, page 308-330, 1987).

### Experiment

I. Material

On Jun. 12, 2003, fifteen plastic crossties (7″×9″×9′) made from the recycled plastics at Recycle Technology International, LLC, Provo, Utah were delivered to the Wood Engineering Laboratory at the University of Illinois, Urbana, Ill. Eight of the fifteen crossties were randomly selected to be subjected to the durability tests (photos 1, 2, 3, 4 and 5).

II. Mechanical Tests

All eight 9-foot crosstie specimens were subjected at first to a static bending test. This test indicated the structural capacity or the breakage of the tie and is important for track load capacity, deformation and surfacing.

A. Static Bending Test (Center Point Flexure Test) (Photo 6)
1. Loading Span and Supports: Center loading and a span length of 60 inches were used to simulate a “center-bound” tie. The tie specimen was supported by two bearing plates (6″×14″) to prevent damage to the tie at the point of contact between tie and reaction support (Photos 6 and 7).
2. Loading Bearing: A 12″ long steel pipe (6″ diameter) was used for applying the load (Photo 8).
3. Speed of Testing: The load was applied continuously throughout the test at a rate of motion of the movable crosshead of 0.10 inch per minute until failure.
4. Load-Deflection Curve: After a 200-pound pre-loading, load-deflection curve was taken to the maximum load; deflections of the neutral plane at the center of the length were taken The maximum bending load was recorded when the loading created a center deflection of 2 inches (Photos 9 and 10).
5. Calculations:
   a. Calculate the maximum bending stress or the modulus of rupture (MOR) for each specimen by the following equation:
      MOR(Psi)=3PL/2bd²
   b. Calculate the modulus of elasticity (MOE) for each specimen by the following equation:
      P₁L3
      MOB(psi)=4bd³y₁
   where
      b=width of specimen, inches
      d=thickness (depth of specimen, inches)
      L=length of span, inches
      P=maximum load, pounds
      P1=load at proportional limit, pounds
      Y1=center deflection at proportional load,

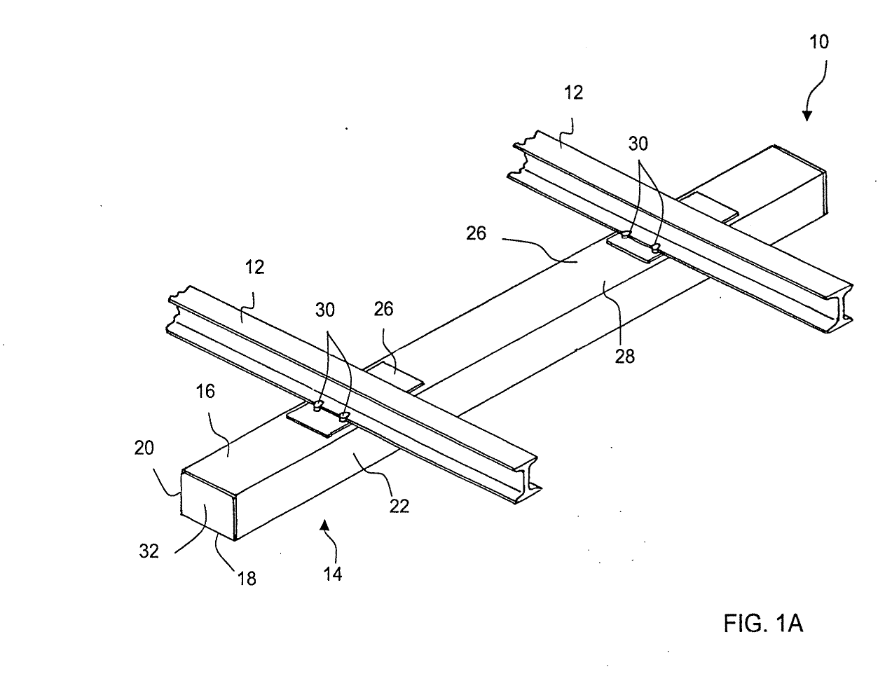

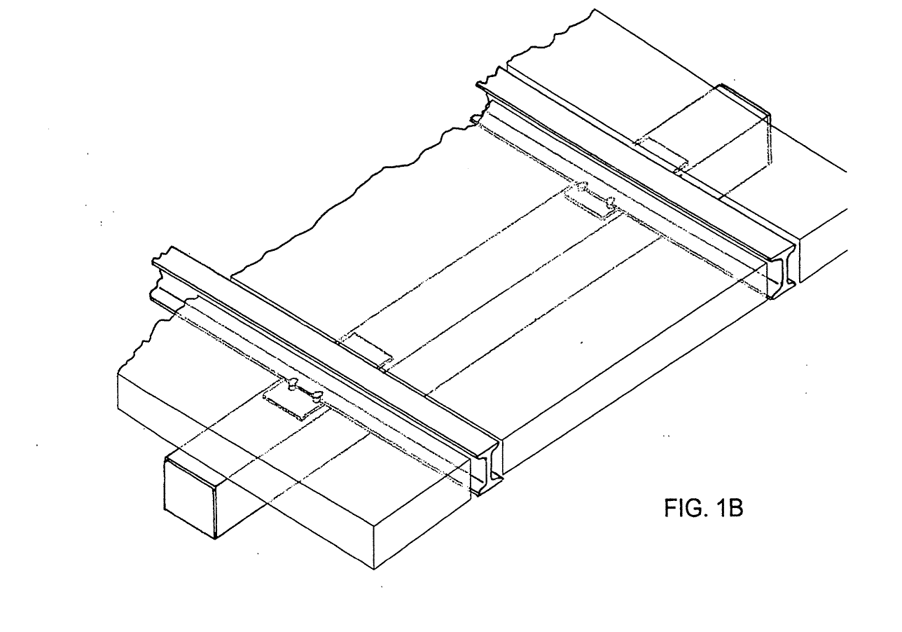

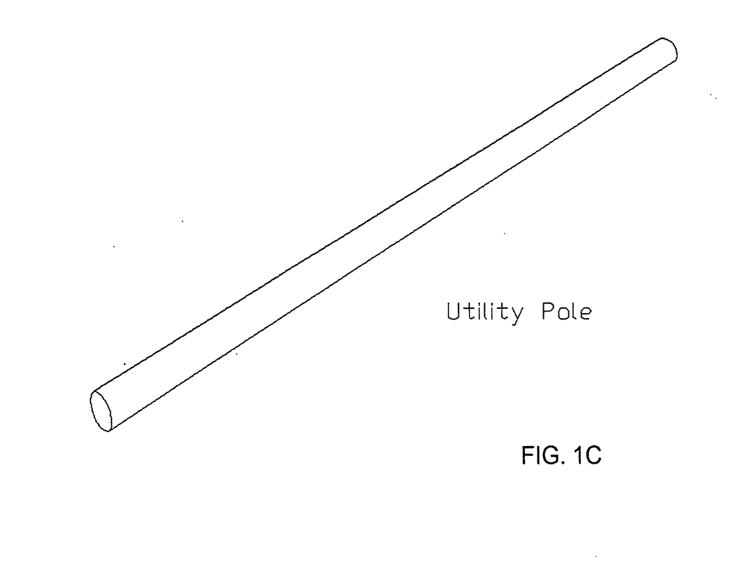

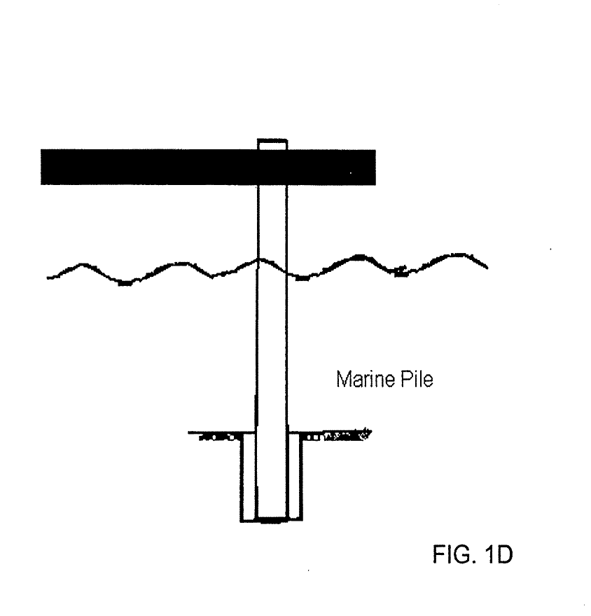

After the static bending test, two 18-inch sections (FIG. 1, and Photo 11) of (7″×9″) samples were cut from each 9-foot crosstie (Photo 12) for conducting the durability analysis. A total of 6 cycles of accelerated laboratory aging test were performed on eight of the 18-inch long section samples. The following tests were conducted on each sample both before and after the accelerated aging test after their weight and dimension had been determined (Photo 13).

B. Compression Perpendicular to Grain Load (24.000 lbs.)

The test determines the crushing capacity for the wood in the critical plate areas (photos 14, 15, and 24).
1. Loading: A 24,000 lbs. load was applied through a movable crosshead and carried through a short section of 115 RE rail to a 7.75 by 13-inch tie plate in turn to the upper surface of the crosstie specimen at equal distances from the ends and at right angles to the length.
2. Speed of Testing: The load was applied continuously throughout the test at a rate of motion of the movable crosshead of 0.024-inch per minute.
3. Load-Compression Curves: It was taken for all specimens up to 24,000 lbs. Load after which the test was discontinued.
4. Calculation: The modulus of elasticity in compression (MOE) was calculated using the following equation:
   E(psi)=Compression stress (Psi)/Strain(in/in)
   Compressive Stress (Psi)=P₁/A
   Compressive Strain (in/in)=Y₁/d
Where:
   P₁=load at proportional limit. pounds
   A=net plate area square inches
   Y₁=compression at proportional limit, inches
   d=thickness or depth of tie specimens, inches

C. Surface Hardness Test (Photos 16, and 17)

This test defines the plate cutting resistance and surface hardness of the tie specimen in the critical plate areas:
1. Specimen Size: The test was made near the tie-plate area of the 18″ long specimens.
2. Loading: A steel ball “2-inch” in diameter was used as a loading head.
3. Speed of Testing: The test was conducted at a speed of 0.25 inches of cross head deflection per minute.
4. Calculations: The maximum load required to embed the “ball” to 0.25 inches into the specimens is the measure of surface hardness (lbs.).

D. Spike Resistance Tests (Photos 26, 27, 28, 29, and 31)

These tests were used to indicate the rail gage and rollover restraint capacity of the ties. The spike drive-in force, the lateral spike resistance; and spike withdrawal resistance were tested. A ⅝″ square and 6½″ long cut-spikes were first inserted into an ½ inch pre-drilled pilot hole (Photos 25 and 30) in the plate area of the tie specimen, so the resistance to withdrawal in plane normal to the tie surface can be measured.
1. Speed of Testing: a) A cut spike was driven into the tie plate surface at a speed of 2 inches per minute; b) the lateral spike resistance test was made at the speed of OJ inches per minute; c) the direct withdrawal test was made at a speed of 0.3 inches per minute.
2. Load was recorded for the tests at the spike head is being bent or displaced 0.2 inches laterally (900 angle) in the lateral spike resistance test.

The spike tests were conducted on the following 7″×9″×18″ samples which were cut tram both ends of each 9-foot specimen after the static bending test (FIG. 1 and Photos 12, 28, and 30).
1. Control or at 0-cycle: 1-B, 2-B, 3-B, 4-B, 5-B, 6-B, 7-B and 8-B.
2. Subjected to six cycles of accelerated aging test: 1-A, 2-A, 3-A, 4-A, 5-A, 6-A, 7-A, and 8-A.
fir. Accelerated Aging Test

A laboratory-aging test was conducted on specimens using the schedule developed for creosote treated oak ties as follows:

| | Exposure | |
|---|---|---|
| Condition | Period | Purpose |
| Vacuum soaking (25″ | 30 minutes | Max swelling occurs |
| or 63.5 cm. Hg., room temp.) | (Photos 18, 19) | in samples |
| Pressure soaking {170 | 30 minutes | Max swelling occurs |
| psi or 1,172 kps.), room | (Photos 18, 19) | in samples |
| temperature | | |
| Freezing (O° F. | 3 hours | To simulate winter |
| or −17.8° C.) | (Photo 20) | temperature |
| Steaming (250° F. | 30 minute warm- | Thermal degradation |
| or 121° C.) (15 psi) | up + 10 hours | of samples |
| | (photo 21) | |
| Oven drying (220° F. | 9.5 hours | Shrinkage occurs to |
| or 121° C.) | | create checks |
| Conditioning (70° F. | About 22 hours | |
| or 21° C.) | (Photo 22) | |
| 90% relative humidity | | |

Eight 7″×9″×18″ specimens were selected to subject the 6 cycles of accelerated aging test. Their codes were 1-A, 2-B, 3-A, 4-A, 5-A, 6-A, 7-A and 8-A.

Results
1. Table 1 listed the weight, dimension, density and specific gravity, average moisture content of all specimens. The proportional limit load and deflection derived from the static bending test, the maximum bending load, maximum bending stress (Modulus of Rupture or MOR), and Modulus of Elasticity (MOE) in bending of eight recycled plastic composite crosstie specimens are shown in Table 2. During the testing, all specimens exhibited large deflection at low loads and did not break at maximum load when reaching two inches of center deflection.

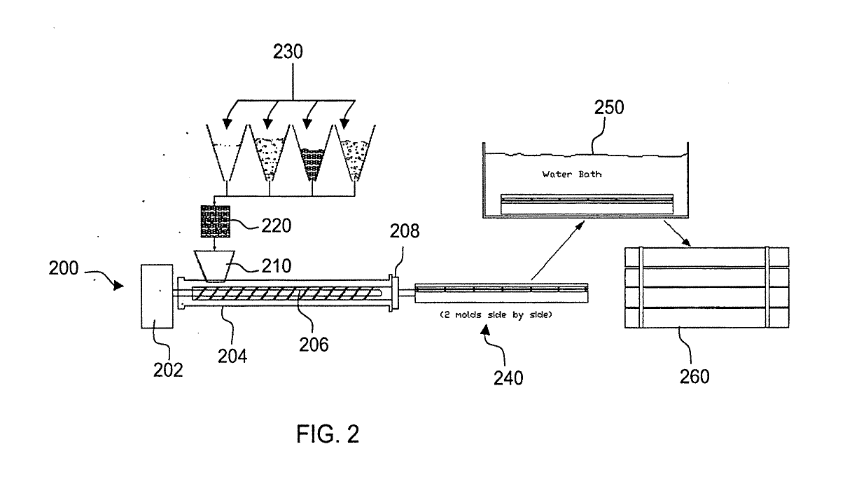

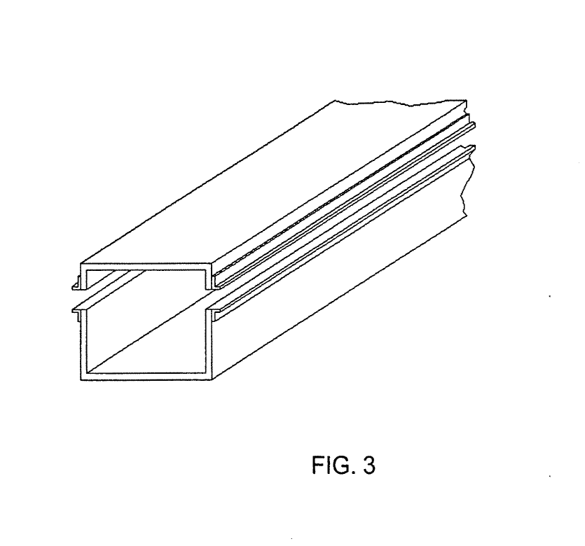

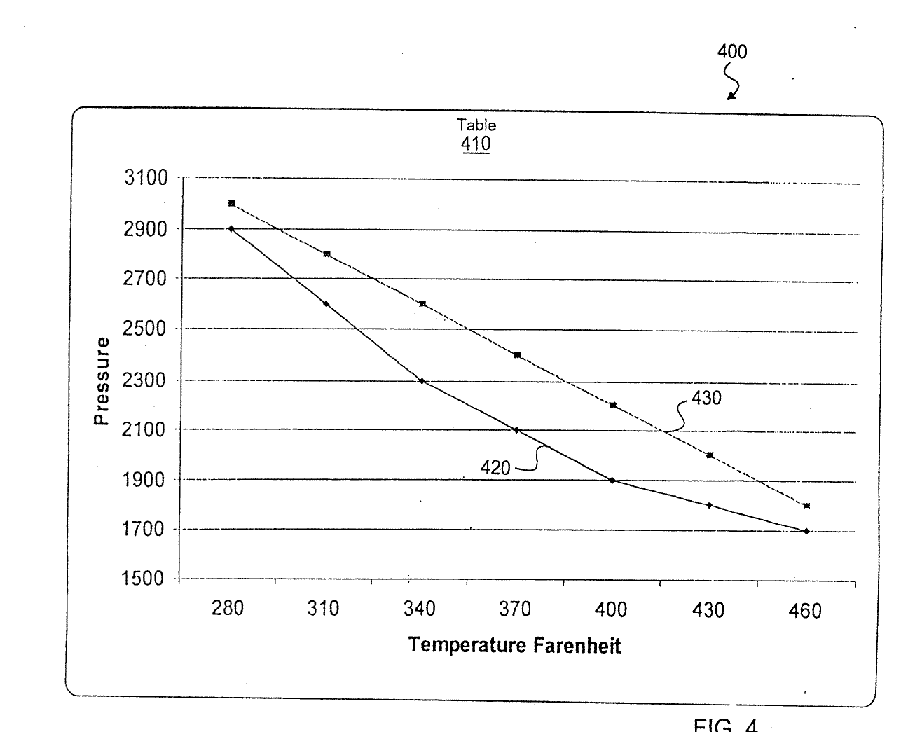

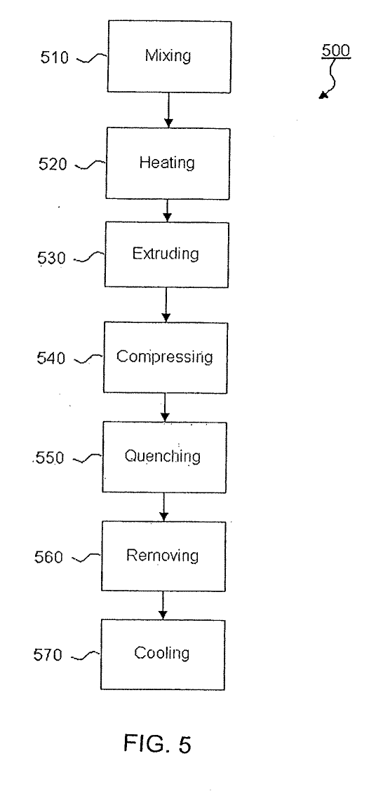

For comparison purposes, the average tested values of the commercial creosote treated oak (including both red and white oaks) crossties are also provided in this study. The set-up of the static bending test is shown in Photos 6-10 and the test results are illustrated in color FIGS. 2 and 3.
2. The effects of six cycles of the accelerated aging test on the average compressive modulus of elasticity (MOE) and the maximum surface hardness values for all eight samples and the creosote treated oak (7″×9″×18″) are shown in Tables 3 and 4, and FIGS. 4 and 5. The results indicate that the eight individual samples exhibited very much the same values in compression MOE property from the initial condition (0-cycle) to the final cycle 6 of aging process. There was a slight drop in average surface hardness values from 0-cycle to cycle 1 aging process. After cycle 1, the surface hardness property remained constant until the end of the 6th cycles.
3. Table 5 and FIGS. 6, 7, and 8, show the effects of artificial weathering on three spike resistance properties of the recycled-plastic composite crossties and the commercial oak crossties. All of the three spike resistance properties of the plastic composite samples were not affected and weakened by the 6 cycles of laboratory-aging test.
4. There was no surface area loss under the plate-area of specimens due to face checks and splits as a result of the accelerated aging exposure as shown in Table 6 and FIG. 9 (Photos 23, 34, and 36). All wood-plastic composite samples did not show any sign of face check and split after the 6-cycle aging test.
5. Photos 32, 33, 34, 35, and 36, demonstrate the visual differences between the a-cycle and 6 cycles of laboratory accelerating aged 8 crosstie samples made from the recycled plastics. The dimensional changes that occurred as the specimen materials progressed in aging or weathering test were recorded both before and after each cycle. However, the dimensional changes of the samples (7″×9″×18″) amounted to between 11.8″ and ⅜″, and appeared to be minimal. The shrinkage and swelling were more pronounced right after the freezing and steaming processes.

Observations

This report contains the results of a study that examined the performance of the composite crossties made from the recycled plastic materials in artificial weathering. The experiment looked at the static bending properties prior to the aging test, the effects of weathering cycles on the compressive modulus, surface hardness, and three spike resistance properties of the crosstie samples.

The following observations can be made based on the test results:
1. These eight composite crossties made from the recycled plastics showed a relatively good surface appearance both in texture and form. On the average, they are about ten percent heavier than the commercial creosote treated oak crossties (Table 1).
2. The plastic composite crossties obtained the average values well below the maximum bending stress (MOR) and the modulus of elasticity (MOE) properties for commercially treated oak crossties (FIGS. 2, 3 and, Table 2). The plastic composite crossties were very flexible and elastic. Even at very large deflection up to 2 inches at center of the span, no physical breakage was noted on all eight specimens.
3. In the compressive MOE (perpendicular to plate area) test, the p crossties made from the recycle plastics obtained about 70 percent and 170 percent average values of those of the creosote treated oak crossties at zero-cycle and 6-cycle, respectively. The plastic crosstie samples exhibited and maintained very good performance in compression property from the 2nd cycle condition to the last 6th cycle-of artificial weathering (Table 3 and FIG. 4).
4. The average surface hardness value of the plastic crosstie samples obtained about 184 percent and 580 percent average values of those of the commercial treated oak crossties at zero-cycle and 6-cycle, respectively (Table 4 and FIG. 5). Their average hardness values were found to be much higher than those of the commercially treated oak crossties in all cases.
5. In the lateral spike resistance test, the crossties made from the recycled politics materials out-performed the commercial treated oak crossties in both before and after the 6-cycle accelerated aging exposure conditions. In the spike withdrawal test, the plastic composite crossties obtained higher average value than the treated oak crossties after the 6 cycles of accelerated aging. It appeared that these plastic crossties showed excellent spike strength retention in comparison to that of the creosote treated oak crossties. However, relatively lower average direct spike withdrawal value was obtained in the new plastic crossties than that of the creosote treated oak crossties (FIGS. 6, 7, 8 and Table 5).
   List of Tables

TABLE 1. Dimension, density, specific gravity, and moisture content of plastic composite crossties

TABLE 2. Static bending modulus of elasticity (MOE) and modulus of rupture (MOR) of full-size, plastic-composite_crossties.

TABLE 3. Effects of 6-cycle accelerated aging on compressive modulus of elasticity (MOE) perpendicular to face of plastic-composite crossties.

TABLE 4. Effects of six-cycle accelerated aging test on the average surface hardness of plastic composite crossties.

TABLE 5. Effects of 6-cycle accelerated aging on the average spike resistance of plastic crossties (pre-bored using ½″ bit).

TABLE 6. Average percent surface area loss (%) under the plate-area (square inch) of plastic crossties due to checks and splits caused by the accelerated aging exposure.

TABLE 1
Dimension, Specific Gravity, Density, and Moisture
Content of Recycled Plastic Specimens

| | | | | | | | Moisture |
|---|---|---|---|---|---|---|---|
| Wood- | Weight | Length | Thickness | Width | Density | Specific | Content |
| Plastics | (lbs.) | (in.) | (in.) | (in.) | (lb/cu. ft) | Gravity | (%) |
| 1 | 235.5 | 110⅛″ | 6¾″ | 8 11/16″ | 63.02 | 1.01 | 2.5 |
| 2 | 252.0 | 109 13/16″ | 6¾″ | 8 11/16″ | 67.60 | 1.08 | 2.0 |
| 3 | 240.5 | 110″ | 6¾″ | 8 13/16″ | 63.51 | 1.02 | 1.5 |
| 4 | 235.5 | 110 1/16″ | 6¾″ | 8 13/16″ | 62.16 | 1.00 | 1.8 |
| 5 | 254.0 | 110½″ | 6 13/16″ | 8 13/16′″ | 66.16 | 1.06 | 2.0 |
| 6 | 253.5 | 110⅜″ | 6 13/16″ | 8 11/16′ | 67.06 | 1.07 | 2.5 |
| 7 | 248.0 | 110 7/16″ | 6¾″ | 8¾″ | 65.70 | 1.05 | 1.6 |
| 8 | 246.5 | 110 3/16″ | 6 11/16″ | 8 11/16″ | 66.54 | 1.07 | 1.5 |
| Average (x) | 245.7 | 110 3/16″ | 6¾″ | 8¾″ | 65.22 | 1.04 | 1.9 |
| Treated Oak | 220.0 | 102 | 7 | 9 | 59.16 | 0.95 | 30.0 |

TABLE 2
Static Bending Modulus of Elasticity (MOE) and Modulus of
Rupture (MOR) of Full-Size Recycled Plastic Crossties

| | Load at | | Maximum | | |
|---|---|---|---|---|---|
| | Prop. Limit | Deflection | Load | MOR | MOE |
| Specimens | (lbs.) | (io.) | (lbs.) | (psi) | (psi) |
| 1 | 1,560 | 0.192 | 8,873 | 2,020 | 164,220 |
| 2 | 2,160 | 0.250 | 9,344 | 2,130 | 174,620 |
| 3 | 1,440 | 00194 | 8,53( ) | 1,920 | 147,890 |
| 4 | 1,200 | 0.154 | 8,133 | 1,830 | 155,250 |
| 5 | 2,400 | 0.308 | 9,337 | 2,060 | 151,030 |
| 6 | 2,400 | 0.308 | 9,037 | 2,020 | 151,030 |
| 7 | 2,400 | 0.328 | 9,208 | 2,080 | 146,750 |
| 8 | 1,400 | 0.193 | 8,260 | 1,920 | 150,760 |
| Average | 1,870 | 0.241 | 8,840 | 2,000 | 155,200 |
| Treated Oaks | 20,000 | 0.365 | 38,220 | 7,810 | 960,000 |
| 52 Commercial | | | | | |
| Tie | | | | | |

TABLE 3
Plate-Area Compressive Modulus of Elasticity (Perpendicular
to face) of Recycled Plastic Crossties

| | | | | | | | | Compres- |
|---|---|---|---|---|---|---|---|---|
| | | | | | | | | sion |
| | Accelerated Lab. Aging Cycle No. | | | | | | | Retention |
| Tie No. | 0 | 1 | 2 | 3 | 4 | 5 | 6 | Ratio. |
| 1 | 22679 | 24100 | 22344 | 22360 | 23285 | 22642 | 22642 | 1.00 |
| 2 | 25040 | 22700 | 22700 | 22700 | 24260 | 24260 | 22700 | 0.91 |
| 3 | 22695 | 23000 | 24268 | 24268 | 24268 | 24268 | 24268 | 1.07 |
| 4 | 21265 | 27330 | 24268 | 21770 | 22963 | 22660 | 22624 | 1.06 |
| 5 | 25624 | 24465 | 27420 | 25610 | 24460 | 24482 | 24827 | 0.97 |
| 6 | 25646 | 25646 | 25646 | 26380 | 26380 | 24509 | 24720 | 0.96 |
| 7 | 24295 | 24295 | 24295, | 24295 | 24295 | 24295 | . 24295 | 1.00 |
| 8 | 24295 | 24295 | .24295 | 24295 | 24295 | 24295 | 24295 | 1.00 |
| Average | 23,942 | 24,475 | 24,405 | 23,960 | 24,276 | 23,926 | 23,796 | 0.99 |
| Creosote | 35,330 | 27,950 | 22,155 | 18,250 | 16,190 | 14,610 | 13,470 | 0.38 |
| Treated | | | | | | | | |
| Oak Tie | | | | | | | | |
| (air-Dry)^{b} | | | | | | | | |

^{a}Compressive MOE Retention Ratio = 6-cycle/0-cycle(control)
^{b}Average value for 84 oak crossties

TABLE 4
Effects of 6-cycle Accelerated Aging on the Average
Surface Hardness of Recycled Plastic Crossties

| | | | | | | | | Compres- |
|---|---|---|---|---|---|---|---|---|
| | | | | | | | | sion |
| | Accelerated Lab. Aging Cycle No. | | | | | | | Retention |
| Tie No. | 0 | 1 | 2 | 3 | 4 | 5 | 6 | Ratio. |
| 1 | 6409 | 6104 | 5940 | 6005 | 4907 | 6309 | 6309 | 0.98 |
| 2 | 8491 | 7359 | 8712 | 7469 | 8401 | 8501 | 8322 | 0.98 |
| 3 | 6699 | 6808 | 7510 | 7341 | 7478 | 7782 | 7035 | 1.05 |
| 4 | 7644 | 6480 | 7588 | 7019 | 7378 | 6833 | 6780 | 0.89 |
| 5 | 9229 | 7670 | 7062 | 7320 | 7779 | 8381 | 7460 | 0.81 |
| 6 | 9473 | 7143 | 7534 | 7156 | 7362 | 7175 | 7943 | 0.84 |
| 7 | 7830 | 7920 | 7449 | 7250 | 8726 | 8590 | 8882 | 1.13 |
| 8 | 6586 | 5960 | 6799 | 6924 | 6909 | 6954 | 7530 | 1.14 |
| Average | 7795 | 6931 | 7324 | 7061 | 7367 | 7566 | 7533 | 0.98 |
| Creosote | 4225 | 3055 | 2340 | 1980 | 1620 | 1420 | 1300 | 0.31 |
| Treated | | | | | | | | |
| Oak Tie^{b} | | | | | | | | |

TABLE 5
Effects of 6-cycle Accelerated Aging on the Average Spike Resistance of
Recycled Plastic Crossties (pre-bored using ½″ bit)^{a}

| Samples | Spike Drive-In | | Spike Direct | | Lateral Resistance | |
|---|---|---|---|---|---|---|
| (7″ × | Force (lbs.) | | Withdrawal (lbs.) | | (0.2″ Displacement) | |
| 9″ × 18″) | New | 6-Cycle | New | 6-Cycle | New | 6-Cycle |
| 1 | 4682 | 8506 | 2000 | 3188 | 2562 | 2605 |
| 2 | 6467 | 8463 | 2408 | 2982 | 3458 | 2500 |
| 3 | 7758 | 8432 | 2943 | 3131 | 2874 | 3167 |
| 4 | 7652 | 7290 | 2545 | 2744 | 3575 | 3065 |
| 5 | 8622 | 9041 | 3100 | 3073 | 3593 | 3370 |
| 6 | 8184. | 8798 | 2790 | 3211 | 3908 | 3269 |
| 7 | 6864 | 9142 | 2412 | 3320 | 3741 | 3252 |
| 8 | 6980 | 8092 | 2248 | 2930 | 3217 | 3371 |
| Average | 7,151 | 8,470 (1.18)^{b} | 2,556 | 3,073 (1.20) | 3,366 | 3,075 (0.91) |
| Commercial | 9,300 | 3,654 (0.39) | 8,000 | 1,400 (0.18) | 3,100 | 1,218 (0.39) |
| Oak^{c} | | | | | | |

^{a}Each value is an average for two tests.
^{b}Retention of the initial value of new tie in ratio.
^{c}Average test values of 84 oak crossties.

TABLE 6
Average Percent Surface Area Loss (%) Under the Plate-Area of
Recycled Plastic Crossties Due to Checks and Splits Caused by the
Accelerated Aging Exposure

| Wood- | Accelerated Lab. Aging Cycle No. | | | | | | |
|---|---|---|---|---|---|---|---|
| Plastics | 0 | 1 | 2 | 3 | 4 | 5 | 6 |
| 1 | 0 | 0 | 0 | 0 | 0 | 0 | 0 |
| 2 | 0 | 0 | 0 | 0 | 0 | 0 | 0 |
| 3 | 0 | 0 | 0 | 0 | 0 | 0 | 0 |
| 4 | 0 | 0 | 0 | 0 | 0 | 0 | 0 |
| 5 | 0 | 0 | 0 | 0 | 0 | 0 | 0 |
| 6 | 0 | 0 | 0 | 0 | 0 | 0 | 0 |
| 7 | 0 | 0 | 0 | 0 | 0 | 0 | 0 |
| 8 | 0 | 0 | 0 | 0 | 0 | 0 | 0 |
| Average | 0 | 0 | 0 | 0 | 0 | 0 | 0 |
| Commercially | 0.9 | 1.1 | 1.8 | 2.9 | 3.9 | 5.2 | 5.2 |
| Treated Oaks | | | | | | | |

The results of the laboratory's tests are presented in Tables 1 through 6 above and in FIGS. 1 through 9 of the laboratory's tests and photographs 1 through 36 of the laboratory's tests here incorporated by reference.

The results given in Table 1 show that all properties of the polymer composite crossties according to the invention are within the ranges specified in the proposed 2003 standards of AREMA. The moisture contents of all specimens according to Table 1 are much lower than the creosote treated oak wood crosstie of comparison, constituting a significant advantage.

The results given in Table 2 show that the properties of the polymer composite crossties according to the invention are within the ranges specified in the proposed 2003 standards of AREMA within the precision of the determination.

The results given in Table 3 show that unlike the creosote treated wood crosstie, the crosstie according to the invention retains its initial properties very well through six aging cycles. After two and more aging cycles the creosote treated wood crosstie has deteriorated to a lower modulus than the crosstie according to the invention

The results given in Table 4 show that the surface hardness of the crossties according to the invention is superior to that of creosote treated wood crossties as originally produced as well as after each of the six accelerated aging cycles.

The results given in Table 5 show that the spike resistance of the samples according to the invention is very well maintained through six aging cycles while that of commercial oak samples deteriorates significantly and is much less after six aging cycles.

The results given in Table 6 show zero surface loss of initial and aged samples according to the invention. While the commercially treated oak crossties are subject to continued area loss initially and even more so after accelerated aging.

FIGS. 1A-1D of the drawings and the following discussion are intended to provide a brief, general description of a suitable crosstie environment 100 in which the invention may be implemented. The illustrated environments in FIG. 1A and FIG. 1B contemplated in the illustrated embodiment of the invention provides a scalable, low cost solution to a crosstie made from a blend or composite of recycled materials. The dimensions of the crosstie are dependent on the intended operating environment. For example, an industrial rail system employing recycled crossties may require longer, thicker crossties than a residential transportation rail system. Additionally, FIG. 1B illustrates a grade crossing in accordance with one embodiment of a transportation rail system using polymeric composite crossties and polymeric grade crossings

The polymeric composite may be useful in replace other traditional wood construction structures. For example, FIG. 1C shows a polymeric composite utility pole according to one embodiment of the present invention. FIG. 1D shows a marine pile according to another embodiment as used in another harsh operating environment.

FIG. 2 of the Drawings is a block diagram of an extrusion process according to one embodiment of the invention. An extrusion-molding system 200 for extruding and molding polymer composite into railroad crossties includes a single-screw extruder 202 having a barrel 204, a screw 206, a die 208 and a feeder 210. Material to be processed reaches the feeder from a mixer 220 in which the filer, the polymeric stiffening component, the polymeric density component, and the polymeric flexibility component, each issuing from its supply container 230, are blended. The extruded polymer composite is shaped in mold 240, which is partially cooled in water bath 250 until the molded product 260 can be removed without losing its shape. Step one sizes the recycled plastic using a granulator or grinder. A series of polymeric compounds may be used as recycled plastic. The polymeric compounds are generally of industrial waste in nature, in which about 80% will not pass through a 60 micro screen. A polymeric composite is produced that contains between 50 and 90 percent polymer. The composite also contains between 10 and 50 percent of the mineral and/or wood based filler, which is non-structural in nature.

Step two preheats the extruder and neck prior to adding the sized recycled plastic. The temperature necessary to breakdown the blend without melting the blend varies according to the pressure produced within the extruder. Pressure may vary accordingly.

Step three mixes portioned by weight the recycled plastics with a filler to form a composite or blended material. The polymeric compound may be mixed in a dry form using mineral based oil as a binding agent to bind the filler component to the polymeric component. The filler may have no known structural or reinforcing properties is selected from a group including Talc, pot ash, fly ash and mineral products of which 100% will pass through a 60 micron screen.

Step four heats and blends the blended composite material within the extruder. The temperature is limited to duration and intensity so as not to liquefy the polymers or break down the polymeric bonds. Heat is transferred into the polymeric composite using an extrusion process with temperatures set between 140 and 500 degrees Fahrenheit to allow complete encapsulation of the non-structural filler as well as to allow bonding and solidification of the independent polymeric and filler compounds. Upon completing the multi-staged heating process, the composite material is extruded by the screw drive.

Step five extrudes and injects the material into the desired extrusion compression mold to form the crosstie. The polymeric compound is forced into the molds via the extruder at a temperature between 140 and 500 degrees Fahrenheit and a pressure of between 1500 and 3000 psi. An exemplary extrusion compression mold, in an exploded view, is illustrated in FIG. 3.

Step six quenches the mold to cool the outer surface of the composite crosstie. This compound is held in the molds and quenched in water that is between 30 and 70 degrees Fahrenheit for a time of between 20 and 120 minutes, preferably between 20 and 60 minutes.

Step seven removes the composite crosstie from the mold. This step may occur after the tie has completely cooled, but the manufacturing process allows the crossties to be removed once the crosstie will maintain its form, but before it is not completely cooled. This dramatically increases the efficiency of the process.

While FIG. 2 only illustrates one extrusion compression process, several other configurations are acceptable and within the scope of at least one embodiment of the invention. For example, an embodiment using only a four sided (two dimensional) mold that incorporates the cooling step six could be continuously fed by the extruder until the extruded crosstie reached a desired length. The partially cooled extruded crosstie could then be to cut prior to completely cooling by a mechanism that would cool the cut ends to maintain form.

FIG. 4 is a chart that illustrates potential embodiments of recycled crossties generated by an extrusion system 400. Specifically, table 410 represents the minimum environmental factors 420 and the maximum environmental factors 430 that may be used to produce one embodiment of the invention.

In one embodiment, a polymeric composite is provided consisting of various polymer materials that produce different physical properties, such as the filler and materials can be bound together without heating to a molten state. This allows the physical properties of the original materials to be maintained and provides a viable structural composite with low energy consumption and no need for controlled cooling.

In other embodiments, the various polymers used in the polymeric compound in quantities more than about 60 percent 3, will add desirable stiffening, density and flexibility properties by quantity. The percentage of the mixture can be adjusted based on the properties required for a given application.

In another embodiment, it is provided that a stiffening component, comprising of polypropylene and or Acrylonitrile Butadiene Styrene (ABS) is used 14. The stiffening component is added at a quantity that will achieve the desired effect. For use in a composite crosstie, the polypropylene or ABS will comprise about 27 percent of the composite crosstie 32.

In another embodiment, it is provided that a density component is added to the polymeric composite 16. The density component is selected from High Density Polyethylene (HDPE) or High Molecular Weight Polyethylene (HMW). The density portion can be adjusted depending on the application of the final product, and it is used to comprise about 21.5% of the composite crosstie 30.

In another embodiment, it is provided that a flexibility component is added to the polymeric composite 18 from a group consisting of Low Density Polyethylene (LDPE), Linear Low Density Polyethylene (LLDPE) and Ethylene Vinyl Acetate (EVA).

In other embodiments, the non-reinforcing filler is stated to be of various materials including, but not limited to talc, fly ash, wood flour, wood pulp, pot ash and combinations of these wood and mineral products. The fillers are used to take up space and are not used as strengtheners in the composite 10.

Mineral oil can be added to the compound during the dry mix phase if needed to bind the filler to the polyolefin components of the mixture during the initial stages of the process to help insure proper dissemination of the filler 13. The mineral oil serves no other purpose, structural or otherwise, in the final product.

Other modifications and structural changes may be made to the polymeric composite described herein without departing from the spirit of the invention and still remain within the scope and range of equivalents of the claims. For example, conventional optional plastics compounding ingredients, additives, and adjuvants can be added to the polymeric composite in minor amounts as needed, such as an antioxidant, a colorant, a flame retardant, and/or a lubricant or binding agent to bind the filler component to the polymeric blend before extrusion. Illustrative materials include antioxidants compiled in 21 CFR 178.2010; carbon black, titanium dioxide, and zinc oxide colorants; antimony trioxide together with a halogen source as flame retardant, and mineral oil as lubricant or binder.

In other embodiments the preferential use of recycled polyolefin is stated. Use of off-spec, dark colored and otherwise undesirable recycled plastics are preferred due to availability and cost. The process allows the use of a broad specification feedstock because the surfaces bond while maintaining the majority of the polymer chains 37. The plastics are not required to meet typical extrusion or injection grade specifications and can be combined without any degradation to the final product. The temperatures at which the mixture is heated can be adjusted along with the duration to ensure that the plastics are not completely liquefied. Polyolefin with a lower melt temperature will liquefy at a higher percentage and will provide a greater quantity of bonding between both plastic and filler materials. The use of backpressure, between 2000 psi and 3000 psi, provided by the extruder 50 is helpful in eliminating voids in the material. No foaming is desired and there is no foaming agent used in the process so that the density of the product is as even throughout as possible.

Turning now to FIG. 5 of the Drawings, embodiments of the invention are described in terms of a polymeric composite manufacturing process with reference to the flowchart. The process to be performed by a system constitutes various machines being configured to manufacture the polymeric composite. Exemplary machines in the system include a means for sizing a polymer for extrusion, a mixer and feeder, an extruder, and at least one compression mold structure. Describing the process by reference to a flowchart enables one skilled in the art to show various production methods for polymeric composites that are useful for structurally demanding shaped articles, such methods including such steps to carry out the process on a suitably configured system. Furthermore, it is common in the art to speak of the process, in one form or another, as taking an action or causing a result. Such expressions are merely a shorthand way of saying that execution of the step by a system causes at least one machine or system component to perform an action or a produce a result.

FIG. 5 of the Drawings is a flowchart that illustrates one embodiment of a polymeric composite manufacturing system 500. The system 500 to form a composite material initially provides filler material and polymer material for mixing in block 510. In one embodiment, prior to introduction of the filler material and polymer material into an extruder of system 500, the polymer blend and filler component are preliminarily mixed together. The extruder 500 continues to mix the filler materials and polymer materials. Exemplary polymer materials are selected from the group consisting of polypropylene, High Density Polyethylene (HDPE), High Molecular Weight Polyethylene (HMW), Low Density Polyethylene (LDPE), ABS, Ethylene Vinyl Acetate (EVA), Linear Low Density Polyethylene (LLDPE), and combinations thereof.

Once the filler material and the polymer material are mixed in block 510 to form a composite material, the system 500 begins heating the composite material in block 520 to less than a melting temperature threshold. In one embodiment, block 520 of the system 500 provides for staged heating within an extruder to a temperature less than a first transition threshold of the composition material.

Upon heating the composite material to a transition threshold, the system 500 begins extruding the composite material in block 530 into at least one mold. In one embodiment, the system 500 extrudes the composite material into the mold at a compression pressure between about 600 psi and about 3100 psi. In one embodiment, the compression pressure within the mold from extrusion is between about 1700 psi and about 3000 psi. The continuous movement of the composite through the extruder is coordinated with the periodic movement of the composite into and out of an extrusion compression mold by using a plurality of extrusion compression molds for receiving extrudate sequentially. The extrusion compression mold dimensions comply with American Railroad Engineering and Maintenance of Way Association (AREMA) specifications for composite railroad ties.

The system 500 begins compressing the composite material in block 540 within the at least one mold following extrusion of the composite material from the extruder. Once the attached mold is filled with extrudate, one embodiment begins quenching an exterior portion of the composite material in block 550 within the mold with a cooling agent. The system 500 continues cooling by quenching in block 550 until the polymeric composite reaches a second transition threshold indicating that the exterior portion of the extruded polymeric composite within the mold structure has obtained sufficient structural integrity to maintain the molded form. In one embodiment, quenching in block 550 rapidly cools the extrusion compression mold after being filled with the polymeric composite for between about 20 to about 120 minutes.

Following quenching in block 550, the mold and polymeric composite contained within are removed from the cooling agent in block 560. The system 500 in block 560 also removes the polymeric composite material from the mold. By removing the composite material in block 560 from the mold prior to complete cooling or solidification of the composite material, the system 500 in one embodiment is able to reduce the number of extrusion compression molds necessary for substantially continuous operation. One exemplary indicator of when the molded configuration may be removed from the extrusion compression mold includes detecting when the molded composite shrinks between about 1 percent by volume and about 2 percent by volume. Other easily measurable indicators include surface temperature of the composite material relative to the temperature of the cooling agent.

Once the composite material is removed from the extrusion compression mold in block 560, the system 500 continues to cool the molded article in block 570 until substantial solidification of the composite material. In one embodiment, cooling in block 570 includes exposure to air at ambient temperature. In one embodiment, dunnage is laid on the bottom of crosstie to facilitate airflow around a substantial portion of the surface of the recently created crosstie.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1-23. (canceled)

24. A system of manufacture comprising:
a means for sizing a polymer for extrusion;
a mixer and feeder;
an extruder having multiple adjustable heat zones for heating and blending a polymer blend having a polymeric stiffening component, a polymeric density component, and a polymeric flexibility component and a filler having minimal reinforcing/structural characteristics into a polymeric composite; and
at least one extrusion compression mold structure operably coupled to the extruder for receiving the polymeric composite and discharging molded polymeric composite therefrom.

25. The system according to claim 24 wherein the multiple heat zones are heated between about 250 degrees Fahrenheit and about 520 degrees Fahrenheit.

26. The system according to claim 24 wherein the polymeric composite is heated to a temperature between about 350 degrees Fahrenheit and about 420 degrees Fahrenheit.

27. The system according to claim 24 wherein the multiple heat zones gradually heat particles of polymeric composite until said particles reach a transition threshold and begin to bond together.

28. The system according to claim 27 wherein the polymeric composite is heated to a temperature threshold less than a melting point of the polymer blend of said composite so that a majority of polymer chains in the polymer blend are maintained.

29. The system according to claim 24 wherein the polymeric composite is extruded at a pressure between about 2000 psi and about 3000 psi.

30. The system according to claim 24, wherein the at least one extrusion compression mold structure is quenched by a cooling agent, once the mold structure is filled, until the polymeric composite reaches the second transition threshold to solidify an exterior portion of the extruded polymeric composite within the mold structure.

31. The system according to claim 24 wherein at least one extrusion compression mold structure is cooled between about 20 to about 120 minutes after being filled with the polymeric composite.

32. The system according to claim 24 wherein said filler is selected from the group consisting of Talc, fly ash, potash, and combinations thereof.

33. The system according to claim 24 wherein said polymer is selected from the group consisting of polypropylene, High Density Polyethylene (HDPE), High Molecular Weight Polyethylene (HMW), Low Density Polyethylene (LDPE), ABS, Ethylene Vinyl Acetate (EVA), Linear Low Density Polyethylene (LLDPE), and combinations thereof.

34. The system according to claim 24 wherein the compression mold structure has inserts on three sides of each mold that create markings and/or molded designs in the polymeric composite.

35. The system according to claim 24 wherein a means for sizing a polymer for extrusion is selected from the group consisting of a granulator, a pelletizer, a prilling machine, a densifier, and grinder.

36-42. (canceled)
